(19) United States
(12) Patent Application Publication
(10) Pub. No.: US 2025/0296623 A1
(43) Pub. Date: Sep. 25, 2025

(54) CONTROL SYSTEM FOR A STEERING SYSTEM OF A VEHICLE

(71) Applicant: JAGUAR LAND ROVER LIMITED, Warwickshire (GB)

(72) Inventors: Bhavika Soni, Whitley, Coventry, Warwickshire (GB); William Ward, Whitley, Coventry, Warwickshire (GB)

(21) Appl. No.: 18/864,126

(22) PCT Filed: May 5, 2023
(86) PCT No.: PCT/EP2023/061992

§ 371 Date: Nov. 8, 2024

(30) Foreign Application Priority Data
May 9, 2022 (GB) 2206751.6

(51) Int. Cl. B62D 6/00; B62D 6/02; B62D 7/15; B62D 15/02

(52) U.S. Cl. CPC B62D 6/002; B62D 6/02; B62D 7/159; B62D 15/025

(57) ABSTRACT

A control system (104) for a steering system (101) of a vehicle (100), the control system comprising one or more controllers, the control system configured to: receive (600) a vehicle speed signal indicative of a current vehicle speed; receive (602) a steering input signal output corresponding to a demanded steering angle of a steered wheel; determine (604) from the received vehicle speed signal when the current vehicle speed reaches zero; and output (606) a control signal to control a steering angle of a steered wheel (103, 106), such that the steered wheel is controlled to turn towards a straight ahead condition, in the event that the current vehicle speed remains zero and the time since the current vehicle speed reached zero is within a time period T.

### TECHNICAL FIELD

The present invention relates to a control system for a steering system of a vehicle; a steering system; a vehicle; and a method of controlling a steering system of a vehicle.

### BACKGROUND OF THE INVENTION

Some vehicle steering systems are electronically controlled, such that the mechanical link between a steering request and a steering output is not present. Such systems are known as ‘steer-by-wire’ systems. An exemplary form of steer-by-wire is in rear wheel steer vehicles. Such steering systems are known to provide varying benefits to a vehicle at differing vehicle speeds. At higher vehicle speeds the rear wheels can be steered in phase with the front wheels, promoting vehicle stability. At lower vehicle speeds the rear wheels can be steered out of phase with the front wheels, providing improved manoeuvrability.

Turning the vehicle wheels when stationary (known as dry steering) can produce unwanted results, for example excessive tyre wear and/or increased loads in the steering actuator. Further it may not be possible to dry steer if the friction between the wheel and the surface it is on is too high and/or the vehicle mass is large.

One approach is to prevent the wheels from turning below a predetermined threshold speed. The disadvantage of this approach is that the vehicle then loses the manoeuvrability advantages provided by rear wheel steer (RWS) systems at low speed.

### SUMMARY OF THE INVENTION

It is an aim of the present invention to address one or more of the disadvantages associated with the prior art.

Aspects of the present invention relate to a control system for a steering system of a vehicle; a steering system; a vehicle; and a method of controlling a steering system of a vehicle.

According to an aspect of the present invention there is provided a control system for a steering system of a vehicle, the control system comprising one or more controllers, the control system configured to: receive a vehicle speed signal indicative of a current vehicle speed; receive a steering input signal output corresponding to a demanded steering angle of a steered wheel; determine from the received vehicle speed signal when the current vehicle speed reaches zero; and output a control signal to control a steering angle of a steered wheel, such that the steered wheel is controlled to turn towards a straight ahead condition, in the event that the current vehicle speed remains zero and the time since the current vehicle speed reached zero is within a time period T.

The invention provides a control system that is operative to return the steered wheels of a vehicle towards a straight ahead condition subject to the vehicle speed being within a time period T of having reached zero. The control system additionally receives a steering input signal which corresponds to a driver demanded steering angle. During the time period T the steered wheels may be steered towards this demanded steering angle as long as the demanded angle takes the steered wheel towards the straight ahead condition. In the event that the demanded steering angle is away from the straight ahead condition then the control system may ignore the received steering input signal output.

The one or more controllers may collectively comprise: at least one electronic processor configured to access at least one electronic memory device and execute the instructions thereon so as to determine when the current vehicle speed reaches zero; and an electrical output configured to output the control signal to a steering actuator of the steering system.

The control system may be configured to output a control signal to control a steering angle of a steered wheel, such that the steered wheel is controlled to turn towards the demanded steering angle, in the event that the current vehicle speed remains zero, the time since the current vehicle speed reached zero is within a time period T and the demanded steering angle is closer toward the straight ahead condition than a current steering angle. The control system may therefore try and steer towards the requested angle as long as the time period condition is met and also that the demanded angle is closer to straight ahead than the current wheel position. It is noted that in the event that the demanded steering angle sits beyond the straight ahead condition then the control system may be configured to turn the steered wheel towards the demanded steering angle but to stop the turn control signal as the wheel reaches the straight ahead condition. In the event that the demanded steering angle is further away from the straight ahead condition than the current steering angle then the control system may be configured to simply hold the current wheel position. As the end of the time period T is reached the control system may be configured to hold the steered wheel in whatever position it has reached. The straight ahead condition referred to herein is understood to mean the position at which the steered wheel is facing straight ahead, therefore in normal use directing the vehicle to continue on a current direction/heading.

The steering system may be a rear wheel steering system.

The time period T may be a predetermined time value stored within a memory of the one or more controllers. Further, the time period T comprises a tuneable time value. This therefore allows the time period during which the vehicle control system may operate to return the steered wheel back towards the straight-ahead condition may be varied, e.g. in response to terrain setting, in response to the environment in which the vehicle is located, user preference etc. In the event that the vehicle comprises an electric vehicle, then the time period T may be tuned in dependence with a charge state of the vehicle, e.g. the time period may be longer for higher charge states and the time period T may be progressively reduced in length for lower charge states.

Conveniently, in one embodiment, the time period T may comprise the time period zero to 2s starting from when the current vehicle speed reaches zero.

At the end of the time period T, the control system may be configured to stop outputting the control signal and to hold the steering angle at its time=T value. For large steered wheel displacements when the current vehicle speed reaches zero this may mean that the steered wheel may not return to the straight-ahead condition by the end of the time period T. To put it another way, when the angular displacement of the wheel is large at the end of the time period T, the steered wheel may not return to the aforementioned straight-ahead condition.

The control system may additionally be configured to: receive a drive mode signal (commonly referred to as “driver mode”) indicative of a drive mode of the vehicle; and not output the control signal in dependence on the drive mode signal. When the vehicle is in certain drive modes, e.g. a “limp home” mode the control system may be configured such that the output a control signal to control the steering angle of the steered wheel is not output.

According to a further aspect of the present invention, there is provided a steering system comprising the control system of the above aspect of the invention. The steering system may comprise a steering actuator that receives the control signal that is output from the control system.

The invention extends to a vehicle comprising the control system steering system of the above aspects of the invention. The vehicle may be a rear wheel steer or all wheel steer vehicle.

According to a further aspect of the present invention, there is provided a method of controlling a steering system of a vehicle, the method comprising: receiving a vehicle speed signal indicative of a current vehicle speed; receiving a steering input signal output corresponding to a demanded steering angle of a steered wheel; determining from the received vehicle speed signal when the current vehicle speed reaches zero; and controlling a steering angle of a steered wheel, such that the steered wheel is controlled to turn towards a straight ahead condition, in the event that the current vehicle speed remains zero and the time since the current vehicle speed reached zero is within a time period T.

The invention extends to a non-transitory computer readable medium comprising computer readable instructions that, when executed by a processor, cause performance of the method of the above aspect of the present invention.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

One or more embodiments of the invention will now be described, by way of example only, with reference to the accompanying drawings, in which:

FIG. 1 shows a top view of a vehicle embodying the present invention;

FIG. 2 shows a top view of another vehicle embodying the present invention;

FIG. 3 shows a block diagram illustrating a system enabling steering of the vehicles of FIGS. 1 and 2;

FIG. 4 shows a plan view of a vehicle travelling at a relatively high speed;

FIG. 5 shows a plan view of a vehicle travelling at a relatively low speed;

FIG. 6 shows a method according to an embodiment of the present invention;

FIG. 7 shows the method of FIG. 6 in more detail.

### DETAILED DESCRIPTION

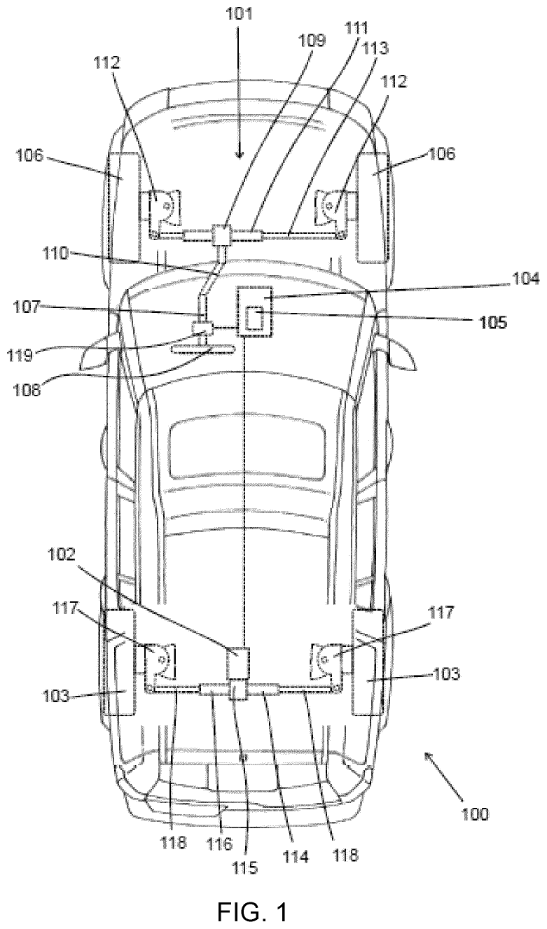

A vehicle 100 embodying the present invention is shown in a top view in FIG. 1. The vehicle 100 is a car that is configured for use both on roads and off-road on various types of terrain. In the present embodiment, the vehicle 100 is a four wheel drive vehicle, but it will be appreciated that many of the features of the vehicle 100 described below are also applicable to front or rear wheel drive vehicles.

FIG. 1 also schematically shows a steering system 101 configured to enable steering of the vehicle 100. The system 101 comprises an actuator 102 configured to cause steering of rear road wheels 103 of the vehicle 100, and also includes a control system 104 comprising a control means in the form of a controller 105 for controlling the operation of the actuator 102.

In the present embodiment, front road wheels 106 of the vehicle 100 are steered by means of a mechanism 107 comprising a steering wheel 108, which is connected to a pinion 109 via a steering column 110. The pinion 109 engages a rack 111 which is connected to steering knuckles 112 by tie rods 113.

The rear wheels 103 are steerable by a mechanism 114 which is operated by the actuator 102. In the present embodiment the actuator 102 is configured to drive a second pinion 115 associated with a second rack 116 which provides forces to steering knuckles 117 of the rear wheels 103 via tie rods 118.

A steering input or position sensor 119 is configured to sense the orientation of the steering wheel 108 and provide signals to the controller 105 indicative of the orientation of the steering wheel 108 and therefore also indicative of the orientation of the front road wheels 106. The controller 105 is configured to provide output signals to the actuator 102 to cause steering of the rear wheels 103 in dependence of the signals received from the steering input sensor 119. However, the output signals provided to the actuator 102 are also dependent on other signals received by the controller 105, as will be described in detail below. It is noted that the steering input signal that is output from the position sensor corresponds to a driver demanded steering angle of a steered wheel (103, 106) of the vehicle 100.

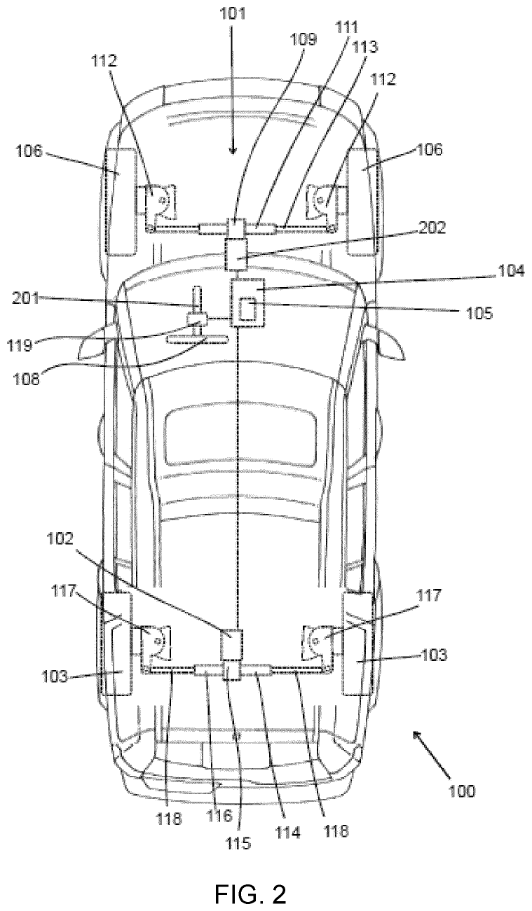

An alternative vehicle 100 embodying the present invention is shown in FIG. 2, in which a system 101 enables “steer-by-wire” of all wheels 103, 106 of the vehicle 100. The vehicle 100 of FIG. 2 has many features in common with that of FIG. 1, which have been provided with the same reference signs. Thus, like the vehicle 100 of FIG. 1, the vehicle 100 of FIG. 2 comprises a steering system 101 comprising pinion 109 and a rack 112 configured to operate steering knuckles 112 via tie rods 113, in order to steer the front wheels 106. A first actuator 102 is configured to drive a second pinion 115 associated with a second rack 116 which provides forces to steering knuckles 117 of the rear wheels 103 via tie rods 118.

However, in the embodiment of FIG. 2, the pinion 109 for driving the front wheels 106 is driven by a second actuator 202. The steering wheel 108 is mounted on a rotatable shaft 201 but it is not mechanically connected to the pinion 109. Instead, as well as providing signals to the actuator 102 for causing steering of the rear wheels 103, the controller 105 is also configured to provide signals to the second actuator 202 to cause steering of the front wheels 106 in dependence on signals it receives from the steering input sensor 119 located on the shaft 201 of the steering wheel 108.

In an alternative embodiment, the vehicle 100 has front wheels that are steer-by-wire, like those of FIG. 2, but the rear wheels 103 are not steerable.

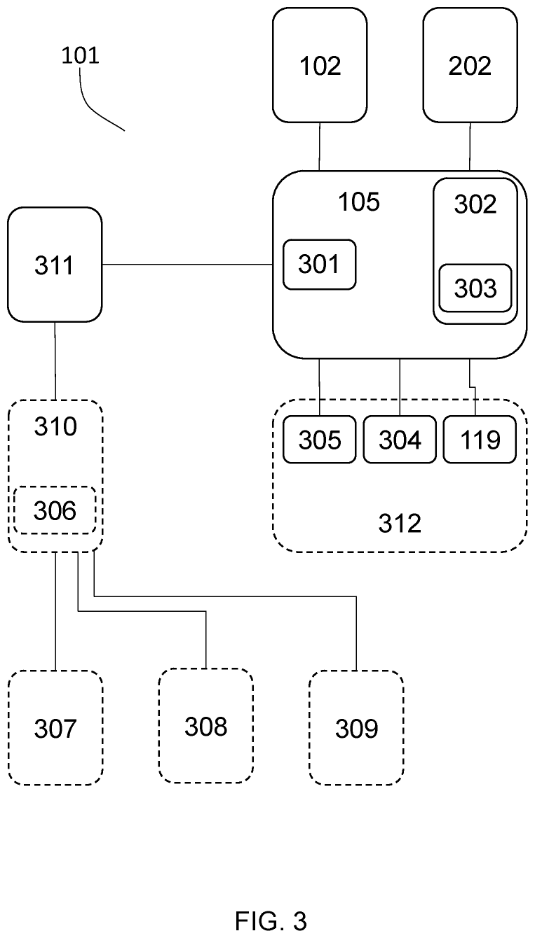

The steering system 101 of FIG. 1, and that of FIG. 2, is illustrated by the block diagram shown in FIG. 3. FIG. 3 also illustrates some exemplary vehicle systems that may be in communication with the steering system 101. The control system 104 comprises a controller 105 which itself comprises an electronic processor 301 and an electronic memory device 302 which stores instructions 303 performable by the processor 301 to cause the processor 301 to perform the method described below and output signals to the first steering actuator 102 to cause steering of the rear wheels 103. In the case of the vehicle 100 of FIG. 2, the processor 301 also provides signals to the second steering actuator 202 for steering the front wheels 106. Although only one controller, processor and memory device are illustrated in FIG. 3, it will be understood that the control system 104 may comprise several controllers 105 and each controller 105 may comprise several processors 301 and/or several electronic memory devices 302, so that the processing as described below may be distributed over several processors.

As well as receiving signals from the steering input sensor 119, the control system 104 receives signals from wheel speed sensing means 304 indicative of a speed of rotation of each road wheel 103, 106. The wheel speed sensing means 304 may comprise wheel speed sensors, each of which is arranged to measure a speed of rotation of a respective one of the wheels 103, 106 and to provide a value for the speed of rotation directly to the controller 105. Alternatively, the wheel speed sensors may form a part of another system such as an antilock braking system (not shown) comprising a control unit configured to receive the signals from the wheel speed sensors and provide wheel speed values to the controller 105.

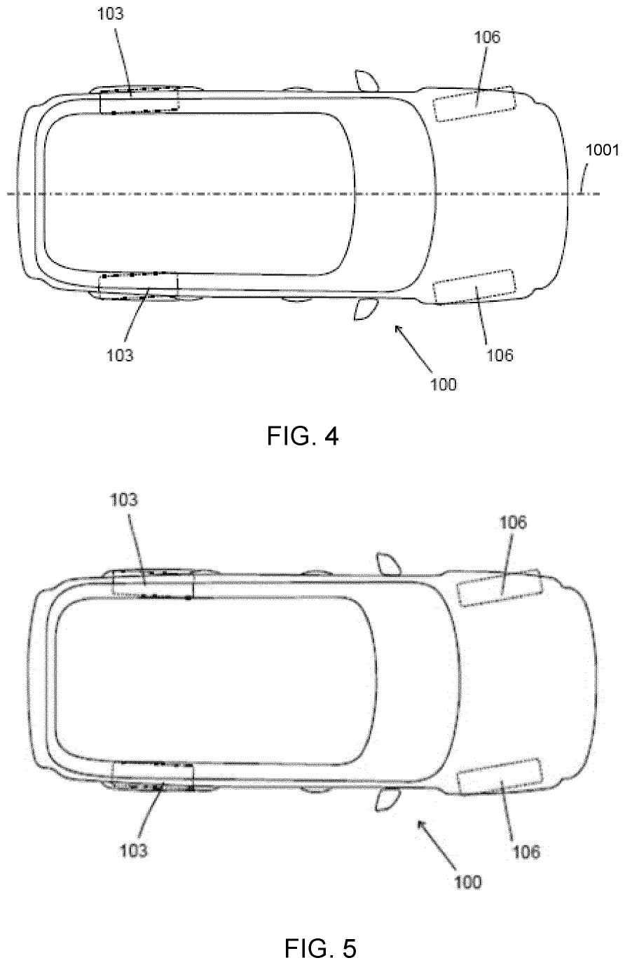

FIGS. 4 and 5 show plan views of the vehicle 100 travelling at a relatively high speed and a relatively low speed respectively. In both FIGS. 4 and 5 the front wheels 106 are turned approximately 15 degrees relative to the longitudinal axis 1001 of the vehicle 100 to cause the vehicle 100 to turn leftwards. In FIG. 4, the current speed of the vehicle 100, as determined from the wheel speed sensing means 304, is above a threshold speed and consequently the rear wheels 103 have been steered in phase with the front wheels 106. That is, because the front wheels 106 have been turned to the left, the rear wheels 103 are also turned to the left. As is known, steering the rear wheels 103 in phase with the front wheels 106 provides the vehicle 100 with increased stability, which is advantageous at high speeds.

In FIG. 4, the rear wheels 103 have only been steered leftwards by about 1.5 degrees, i.e. a tenth of the angle turned by the front wheels 106. The proportion of the front wheel steering angle by which the rear wheels 103 have been steered is referred to herein as the gain value. Thus, in this example the rear wheel steering has a gain value of +0.1 (=1.5/15).

In FIG. 5 the current speed of the vehicle 100 is below the threshold speed and consequently the rear wheels 103 have been steered out of phase with the front wheels 106. That is, because the front wheels 106 have been turned to the left, the rear wheels 103 have been turned to the right. Stability of the vehicle 100 is not an issue at low speeds and, as is known, steering the rear wheels 103 out of phase with the front wheels 106 provides the vehicle 100 with increased agility.

The rear wheels 103 have been steered rightwards by about 3 degrees, i.e. a fifth of the angle turned by the front wheels 106. Thus, in this example the rear wheel steering has a gain value of −0.2(=−3/15), i.e., the absolute value (0.2) of the gain value is higher than the gain value for speeds above the threshold speed, but the gain value is negative due to the rear wheels 103 being turned out of phase with the front wheels 106.

Depending upon a user's style of driving or a type of terrain on which the vehicle 100 is travelling, a particular set of vehicle characteristics (a “drive mode”) may be most appropriate, for example one particular accelerator pedal map may be more appropriate than others, and similarly one particular transmission map and one particular set of stability control settings may be most appropriate. To enable a user to select the most appropriate settings for a chosen style of driving or a particular terrain, the vehicle 100 also comprises a user input device (UID) 311 configured to enable a user to indicate to the vehicle control system 310 a selected drive mode. For example, the user may select a standard mode (or normal mode) when driving on tarmac roads and the vehicle control system 310 controls the ECU 307, the TCU 308 and the SCU 309 to operate in a mode suitable for the tarmac road surface. Alternatively, the user may select another mode, such as a grass, gravel and snow mode for driving over a terrain that provides a low coefficient of friction, or a sand mode for driving on a deformable surface such as sand, which provides a very low coefficient of friction, or a rock crawl mode for driving on rough surfaces with high friction. In response to such a user indication, the vehicle control system 310 controls the ECU 307, the TCU 308 and the SCU 309 to operate in a mode suitable for the indicated type of terrain. The mode selected by the use of the user input device 311 is also provided to the controller 105 and may be used to determine signals provided to the first steering actuator 102 and/or the second steering actuator 202.

The user input device 311 may comprise a switch or switches, a touch screen device, or other electrical or electronic device suitable for enabling a user to provide an indication of a mode they wish to select.

The vehicle control system 310 may comprise a terrain estimation system (TES) 306. Such a system is known and described in the applicant's UK patent GB2492655B and US patent application published as U.S. Pat. No. 2014350789A1. The terrain estimation system 310 is configured to select a drive mode that is the most appropriate mode for the subsystems 307, 308, 309 based on measurements indicative of the terrain on which the vehicle 100 is travelling, to enable the vehicle control system 310 to automatically control the subsystems 307, 308, 309 to operate in the selected mode.

The TES 306 receives signals from terrain sensing means 312 comprising various different sensors and devices for providing information indicating the type of terrain on which the vehicle 100 is travelling. The terrain sensing means 312 may include the aforementioned IMU 305, wheel speed sensing means 304, steering input sensor 119, as well as other sensors (not shown), such as an ambient temperature sensor, an atmospheric pressure sensor, an engine torque sensor, a brake pedal position sensor, an acceleration pedal position sensor, ride height sensors, etc. Various outputs from the terrain sensing means 312 are used by the terrain estimation system 310 to derive a number of terrain indicators. For example, a vehicle speed is derived from the wheel speed sensors, wheel acceleration is derived from the wheel speed sensors, the longitudinal force on the wheels is derived from the IMU 305, and the torque at which wheel slip occurs (if wheel slip occurs) is derived from the motion sensors of the IMU 305 to detect yaw, pitch and roll. The terrain indicators are then processed to determine a probability that each of the different drive modes is appropriate, and thereby determine which of the modes is most appropriate for the operation of the subsystems. In its automatic mode, the terrain estimation system 310 continually determines for each mode the probability that it is appropriate and in dependence on another mode having a consistently higher probability than the currently selected control mode, the vehicle control system 310 commands the subsystems to operate in accordance with that other mode.

The mode determined automatically by the terrain estimation system 306 or selected by the use of the user input device 311, is also provided to the controller 105, and may be used to determine signals provided to the first steering actuator 102 and/or the second steering actuator 202.

The first steering actuator 102 is operable to provide a torque sufficient to turn the wheels 103 of the vehicle 100 at the lower and higher speeds as described above in relation to FIG. 3 and FIG. 4.

As the vehicle 100 reduces speed the wheels 103 may be returned to a straight ahead condition in dependence on a determined time value at which the vehicle speed will reach zero. A control system 104 that is operative in this manner is described in in the applicant's UK patent GB1809351.8.

In some driving conditions, e.g., rapid deceleration as the vehicle is approaching a junction, the wheels 103, 106 may not be full returned to a straight ahead condition as the vehicle speed reaches zero. In other driving scenarios, where the wheels may or may not have returned to a straight ahead condition as the vehicle speed reaches zero, the driver may turn the steering wheel 108 thereby causing a steering input signal output from the steering input sensor 119 to be received by the control system 104.

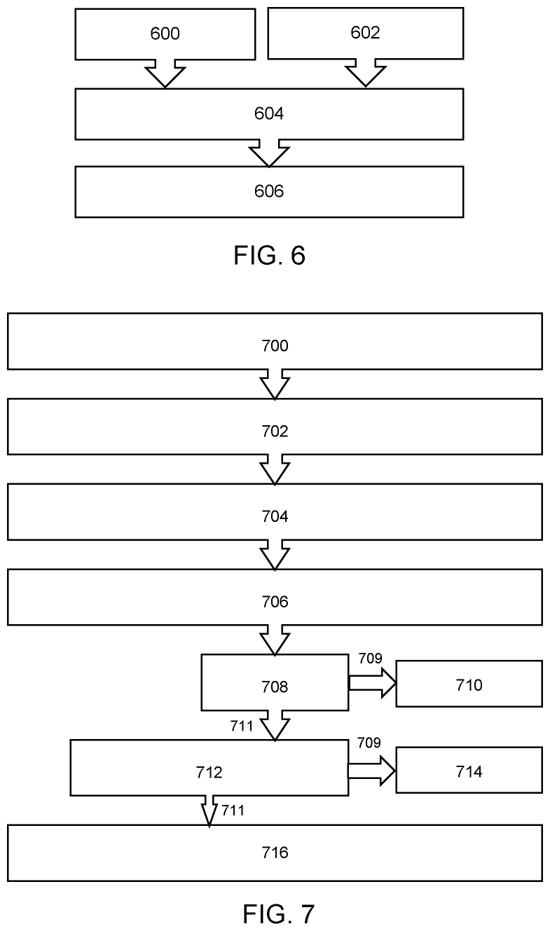

According to embodiments of the present invention, as described in relation to FIGS. 6 and 7, the control system is operative to output control signals to control the steering angle of a steered wheel in accordance with the logic flow and conditions set out below.

Turning to FIG. 6 the method of controlling a steering system 101 of a vehicle 100 according to an embodiment of the present invention is shown.

In step 600, a vehicle speed signal is received from the wheel speed sensing means 304 by the controller 105 within the control system 104. The vehicle speed signal is indicative of the current speed of the vehicle 100.

In step 602, the controller 105 receives a steering input signal output from the steering input sensor 119 that senses the orientation of the steering wheel 108. The signal received from the sensor 119 is indicative of the orientation of the steering wheel 108 and therefore also indicative of the orientation of the front road wheels 106. The position of the actuator 102 associated with the rear wheels 103 is indicative of the angle of the rear wheels 103, with an actuator position of 0 mm corresponding to the straight ahead condition.

It is noted that the signals received by the controller 105 in steps 600 and 602 above are continuously received and the numbering of the various steps does not indicate any ordering of the steps.

In step 604 the controller 105 determines when the current vehicle speed reaches zero and then in step 606, while the current vehicle speed remains zero and the time since the current speed has reached zero is within a time period T, then a control signal is output by the control system 104 to the actuator(s) (102, 202) to control the steering angle of a steered wheel (103, 106), such that the steered wheel is controlled to turn towards a straight ahead condition.

The processing sequence within the controller 105 that corresponds to steps 604 and 606 above is shown in more detail in FIG. 7.

In step 700 the controller 105 performs a vehicle speed check based on the vehicle speed signal received from the wheel speed sensing means 304.

In step 702 the controller 105 determines from the vehicle speed check in step 700 that the current vehicle speed has reached zero.

In step 704 the controller 105 monitors for how long the current vehicle speed has been zero and in step 706 the controller compares the demanded steering angle of a steered wheel (103, 106) to the actual position of the steered wheel (e.g. as determined from the actuator position 102, 202 or from the steering input sensor 119).

The controller 105 then checks, at decision point 708, if the conditions—current speed=zero and time (t) for which speed has been zero<time period T—are true.

If the condition t<T is not satisfied then the controller 105 controls, at step 710, the steered wheel to hold its current position (i.e. the control signal output by the control system 104 maintains the steered wheel in its current position).

If the condition t<T is satisfied then the controller 105 proceeds to a further decision point 712 in which the controller checks whether the demanded steering angle of a steered wheel (103, 106) is closer to the straight ahead position than the current steering angle position.

If the demanded steering angle is further away from the straight ahead position than the current steering angle then the controller 105 controls, at step 714, the steered wheel to hold its current position (i.e. the control signal output by the control system 104 maintains the steered wheel in its current position).

If the demanded steering angle is closer to the straight ahead position than the current steering angle then the controller 105 controls, at step 716, to turn towards a straight ahead condition (i.e. the control signal output by the control system 104 controls the steered wheel to turn towards the straight ahead condition). This straight ahead condition may correspond to an actuator position of 0 mm.

It is noted that the control signal output by the control system 104 and/or controller 105 controls the actuator (102, 202) to turn the steered wheel.

The control system 104 will continue to monitor both the current vehicle speed and the time since the vehicle speed reached zero. In the event of either condition no longer being satisfied then the control system 104 and/or controller 105 will cease outputting the control signal to the actuator (102, 202) that is configured to turn the steered wheel and will either output a control signal to hold the steered wheel in position (e.g. if the time t exceeds the time period T) or may control the steered wheels in accordance with a selected driving mode (e.g. if the vehicle speed is no longer zero). The time period T may be stored within the memory 302 of the controller 105 and may be a tuneable value that can be varied by the vehicle manufacturer, a vehicle service entity or even the driver.

In the event that the vehicle is an electric vehicle then controlling the steered wheels to turn when the vehicle is stationary may be dependent on the charge state of the vehicle. For example, if the vehicle is fully charged or has a charge state above a certain threshold then the time period T may be set to a relatively longer period than if the vehicle is in a low charge state. The control system 104 may be configured to alter the time period T upon a received charge state of the vehicle. In one preferred embodiment then the time period T may comprise the period from t=0s to t=2s from when the vehicle speed reaches zero.

As noted above the driving mode determined automatically by the terrain estimation system 306 or selected by the use of the user input device 311, may also be provided to the controller 105, and may be used to determine signals provided to the first steering actuator 102 and/or the second steering actuator 202. In particular, in certain drive modes (e.g. some off road drive modes) the control system 104 may not output the control signal even if the logic conditions described above in relation to FIG. 7 are met.

A numeral summary for FIG. 3 is presented in table 1. A numeral summary for FIG. 6 is presented in table 2. A numeral summary for FIG. 7 is presented in table 3.

TABLE 1

| | |
|---|---|
| 102 | First Steering Actuator |
| 202 | Second Steering Actuator |
| 105 | Control Means |
| 301 | Processor |
| 302 | Memory |
| 311 | User Input Device |
| 310 | Vehicle Control System |
| 306 | Terrain Estimation System |
| 305 | IMU |
| 304 | Wheel Speed Sensing Means |
| 119 | Steering Position Sensor |
| 312 | Terrain Sensing Means |
| 307 | Engine Control Unit (ECU) |
| 308 | Transmission Control Unit (TCU) |
| 309 | Suspension Control Unit (SCU) |

TABLE 2

| | |
|---|---|
| 600 | Receive vehicle speed signal |
| 602 | Receive steering input signal output |
| 604 | Determine when vehicle speed reaches zero |
| 606 | Output control signal |

TABLE 3

| | |
|---|---|
| 700 | Vehicle speed check |
| 702 | Determine vehicle speed is zero |
| 704 | Determine time that v = 0 |
| 706 | Compare demanded steering angle |
| | versus current position |
| 708 | Is v = 0 and t < T? |
| 709 | No |
| 710 | Hold current position |
| 711 | Yes |
| 712 | Is demanded steering angle closer |
| | to straight ahead position? |
| 714 | Hold current position |
| 716 | Steer towards requested angle |

The, or each, electronic processor 301 may comprise any suitable electronic processor (e.g., a microprocessor, a microcontroller, an ASIC, etc.) that is configured to execute electronic instructions. The, or each, electronic memory device 302 may comprise any suitable memory device and may store a variety of data, information, threshold value(s), lookup tables or other data structures, and/or instructions therein or thereon. In an embodiment, the memory device 302 has information and instructions for software, firmware, programs, algorithms, scripts, applications, etc. stored therein or thereon that may govern all or part of the methodology described herein. The processor, or each, electronic processor 301 may access the memory device 302 and execute and/or use that or those instructions and information to carry out or perform some or all of the functionality and methodology describe herein.

The at least one memory device 302 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 105 have been described comprising at least one electronic processor 301 configured to execute electronic instructions stored within at least one memory device 302, which when executed causes the electronic processor(s) 301 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

1. A control system for a steering system of a vehicle, the control system comprising one or more controllers, the control system configured to:
receive a vehicle speed signal indicative of a current vehicle speed;
receive a steering input signal output corresponding to a demanded steering angle of a steered wheel;
determine from the received vehicle speed signal when the current vehicle speed reaches zero; and
output a control signal to control a steering angle of a steered wheel, such that the steered wheel is controlled to turn towards a straight ahead condition, in the event that the current vehicle speed remains zero and the time since the current vehicle speed reached zero is within a time period T.

2. The control system of claim 1 wherein the one or more controllers collectively comprise:
at least one electronic processor configured to access at least one electronic memory device and execute the instructions thereon so as to determine when the current vehicle speed reaches zero; and
an electrical output configured to output the control signal to a steering actuator of the steering system.

3. A control system according to claim 1, wherein the control system is configured to output a control signal to control a steering angle of a steered wheel, such that the steered wheel is controlled to turn towards the demanded steering angle, in the event that the current vehicle speed remains zero, the time since the current vehicle speed reached zero is within a time period T and the demanded steering angle is closer toward the straight ahead condition than a current steering angle.

4. A control system according to claim 1, wherein the steering system is a rear wheel steering system.

5. A control system according to claim 1 wherein the time period T is a predetermined time value stored within a memory of the one or more controllers.

6. A control system according to claim 1 wherein the time period T comprises a tuneable time value.

7. A control system according to claim 6, wherein the vehicle comprises an electric vehicle and the time period T is tuned in dependence with a charge state of the vehicle.

8. A control system according to claim 1, wherein the time period T comprises the time period zero to 2s starting from when the current vehicle speed reaches zero.

9. A control system according to claim 1 wherein, after the time period T, the control system is configured to stop outputting the control signal and to hold the steering angle at its time=T value.

10. A control system according to claim 1 wherein the control system is configured to:
receive a drive mode signal indicative of a drive mode of the vehicle; and
not output the control signal in dependence on the drive mode signal.

11. A steering system comprising the control system of claim 1 and a steering actuator.

12. A vehicle comprising the control system of any one of claims 1 to 10 or the steering system of claim 11.

13. A vehicle according to claim 12 wherein the vehicle is a rear wheel steer or all wheel steer vehicle.

14. A method of controlling a steering system of a vehicle, the method comprising:
receiving a vehicle speed signal indicative of a current vehicle speed;
receiving a steering input signal output corresponding to a demanded steering angle of a steered wheel
determining from the received vehicle speed signal when the current vehicle speed reaches zero; and
controlling a steering angle of a steered wheel, such that the steered wheel is controlled to turn towards a straight ahead condition, in the event that the current vehicle speed remains zero and the time since the current vehicle speed reached zero is within a time period T.

15. A non-transitory computer readable medium comprising computer readable instructions that, when executed by a processor, cause performance of the method of claim 14.
